(19) United States
(12) Patent Application Publication
(10) Pub. No.: US 2024/0354494 A1
(43) Pub. Date: Oct. 24, 2024

(54) GENERATING, APPLYING, AND VERIFYING AUDIO SIGNATURES FOR DIGITAL DOCUMENTS

(71) Applicant: Dropbox, Inc., San Francisco, CA (US)

(72) Inventors: Daniel S. Crosta, Beacon, NY (US); Alexander Shubin, San Jose, CA (US)

(21) Appl. No.: 18/302,464

(22) Filed: Apr. 18, 2023

(51) Int. Cl. G06F 40/174; G06V 30/19; G10L 13/02; G10L 17/22

(52) U.S. Cl. CPC G06F 40/174; G06V 30/19; G10L 13/02; G10L 17/22

(57) ABSTRACT

The present disclosure relates to systems, non-transitory computer-readable media, and methods for generating and applying audio signatures to digital documents based on receiving audible approval for a signature. In particular, in one or more embodiments, the disclosed systems field prompt audio files that include prompts for signable fields within a document. Further, in one or more embodiments, the disclosed systems receive audible approval in response to a field prompt audio file. In some embodiments, based on the audible approval, the disclosed systems generate an audio signature and apply the audio signature to the signable field of the digital document.

### BACKGROUND

Recent years have seen significant improvements in hardware and software platforms for electronic documents. Accordingly, the prevalence of electronic signature systems has greatly increased. Many existing electronic signature systems provide various methods to utilize electronic signatures in electronic documents without printing and scanning. To illustrate, in some existing electronic signature systems, the user must adopt an electronic signature by typing the signature using a physical or digital keyboard. Additionally, some existing electronic signature systems require the user to draw a freehand version of a signature in a bounded area using an input device such as a mouse or touchscreen.

Although existing systems can record electronic signatures using typing or touch input, such systems have a number of problems in relation to accuracy and flexibility of operation. For instance, existing systems inaccurately capture signature information. Specifically, existing systems can receive signature input in a bounded area and “clip” any input received out of the bounded area. Accordingly, many existing systems fail to capture all of the signature and produce an incomplete resultant electronic signature. To avoid this result, users are required to provide the signature slowly and carefully, which can also change the appearance of the signature and lead to an inaccurate version of a digital signature.

Moreover, existing systems also lack flexibility, as many users lack physical dexterity or visual ability to enter a signature using common digital input devices such as a mouse, keyboard, trackpad, or touchscreen. For example, users with hand or arm maladies, individuals that are not familiar with input devices, or individuals with large hands or fingers commonly have difficulty with existing systems' options for entering electronic signatures, especially in a bounded area. In another example, users with visual impairment are often unable to provide a digital signature because existing systems are unable to generate or provide direction to a signing device as to where or how to sign, or even what a document requests that a user agree to. Further, able-bodied users may often find themselves in situations where use of computing devices in the manner that existing systems require is inconvenient or even unsafe. The rigid and inflexible approach of existing systems in generating digital signatures fails to generate a signature in these situations.

These along with additional problems and issues exist with regard to existing digital signature systems.

### BRIEF SUMMARY

Embodiments of the present disclosure provide benefits and/or solve one or more of the foregoing or other problems in the art with systems, non-transitory computer-readable media, and methods generating an audio prompt for a signable field in a digital document, and generating an audio signature for the digital document by receiving and interpreting an audio response. More specifically, in one or more embodiments, the disclosed systems generate a field prompt audio file for a digital document based on a signable field within the digital document. Accordingly, in some embodiments, the disclosed systems provide the field prompt audio file to a client device and receive an audio response including audible approval of the signable field via the client device. Thus, in one or more embodiments, the disclosed systems utilize the audio response to generate an audio signature. In some embodiments, the disclosed systems apply the audio signature to the digital document to generate a signed digital document.

Additional features and advantages of one or more embodiments of the present disclosure are outlined in the description which follows, and in part will be obvious from the description, or may be learned by the practice of such example embodiments.

### BRIEF DESCRIPTION OF THE DRAWINGS

The detailed description provides one or more embodiments with additional specificity and detail through the use of the accompanying drawings, as briefly described below.

FIG. 1 illustrates a diagram of an environment in which an audio signature management system can operate in accordance with one or more embodiments.

FIG. 2 illustrates a process for providing audio corresponding to a digital document to a client device in accordance with one or more embodiments.

FIG. 3 illustrates a process for generating and applying an audio signature to a digital document in accordance with one or more embodiments.

FIG. 4 illustrates a process for modifying the workflow of providing an audio signature for a digital document based on user commands in accordance with one or more embodiments.

FIG. 5 illustrates a process for applying various types of digital signatures to a digital document in accordance with one or more embodiments.

FIG. 6 illustrates an example graphical user interface presenting an example signed digital document including an audio signature in accordance with one or more embodiments.

FIG. 7 illustrates a schematic diagram of an audio signature management system in accordance with one or more embodiments.

FIG. 8 illustrates a flowchart of a series of acts for generating and applying an audio signature in accordance with one or more embodiments.

FIG. 9 illustrates a block diagram of an example computing device for implementing one or more embodiments of the present disclosure.

### DETAILED DESCRIPTION

This disclosure describes one or more embodiments of an audio signature management system that generates and applies audio signatures by generating audio prompts for signable fields in documents and interpreting verbal responses to those prompts. To illustrate, in one or more embodiments, the audio signature management system generates document audio files including field prompt audio files to play to a client device to solicit audio signatures. Further, in one or more embodiments, the audio signature management system receives audio responses to various field prompt audio files. Accordingly, in some embodiments, the audio signature management system interprets and/or validates the audio response to identify audible approval from the audio response. Based on the audible approval in the audio response, in one or more embodiments, the audio signature management system generates an audio signature and applies it to the corresponding audio field in the digital document.

As mentioned, in one or more embodiments, the audio signature management system generates a field prompt audio file for a digital document (e.g., an audio file corresponding to a digital document that includes a signature field). More specifically, in some embodiments, the audio signature management system provides a digital document to an optical character recognition engine to generate text from the digital document. Further, in one or more embodiments, the audio signature management system recognizes signable fields within the digital document and generates text prompts corresponding to those signable fields. Accordingly, in some embodiments, the audio signature management system utilizes a text-to-speech engine to generate a field prompt audio file(s) corresponding to the digital document to provide to a client device for signature.

Upon providing the document audio file(s) to a client device, in one or more embodiments, the client device plays the document audio file(s) including at least one field prompt audio file. Further, the client device can detect audio response to the field prompt audio file and provide the audio response to the audio signature management system. In some embodiments, the audio signature management system can interpret the audio response by detecting the content of speech from the audio response. To illustrate, the audio signature management system can extract verbal information from the audio response to apply to the digital document. In addition, in some embodiments, the audio signature management system determines whether the audio response includes approval for signing a signable field.

In response to determining that an audio response includes approval to sign a signable field, in one or more embodiments, the audio signature management system generates an audio signature. Further, in one or more embodiments, the audio signature management system provides the audio signature to a third-party that computes a hash for the audio signature. In addition, in some embodiments, the third-party system validates the audio signature and provides the audio signature back to the audio signature management system. In one or more alternative embodiments, the audio signature management system can hash and validate the audio signature.

Further, in some embodiments, the audio signature management system utilizes biometric data to validate an audio signature. To illustrate, in one or more embodiments, the audio signature management system identifies biometric data corresponding to a user account associated with a client device. Further, in some embodiments, the audio signature management system authenticates an audio file including the audible approval for signing the signable field based on the biometric data.

Additionally, in some embodiments, the audio signature management system generates a signed digital document by applying the audio signature to the digital document. In some embodiments, the audio signature management system embeds signature data into the digital document. To illustrate, the audio signature management system can embed an audio file including the audio approval of the audio signature into the digital document. In addition, in one or more embodiments, the audio signature management system modifies the digital document with visual indications of the signature and/or explanations corresponding to the signature.

Further, in one or more embodiments, the audio signature management system modifies presentation of audio file(s) corresponding to a digital document based on various user interactions. For example, in some embodiments, the audio signature management system generates a summary of the digital document based on user request. In addition, or in the alternative, the audio signature management system can provide a summary based on determining that a user account corresponding to a client device has already signed similar documents. Additionally, in some embodiments, the audio signature management system can utilize voice commands to modify playback of audio files, or to check digital document or signature status.

Further, in one or more embodiments, the audio signature management system can generate and apply different types of digital signatures to a digital document. For example, upon generating a signed digital document including an audio signature, the audio signature management system can provide the signed digital document to an additional client device. The audio signature management system can receive indication of user input from the additional client device approving a touch-screen based digital signature. The audio signature management system can generate a signed digital document including both the audio signature and the non-audio digital signature. Accordingly, the audio signature management system can integrate various signature systems for improved flexibility.

As also mentioned above, in one or more embodiments, the audio signature management system receives information for non-signature fillable fields in a digital document. For example, a digital document can include fillable text fields, drop-down menus, multiple choice questions, and other information fields. In one or more embodiments, the audio signature management system generates audio files for digital documents with audio prompts for these additional fields. Accordingly, the audio signature management system can receive audio responses to these prompts from client devices. In some embodiments, the audio signature management system converts verbal information from these audio responses into text and applies the text to the digital document by filling the additional fields based on the converted text.

The audio signature management system provides many advantages and benefits over existing systems and methods. For example, the audio signature management system improves accuracy relative to existing systems. Specifically, by utilizing audio files to prompt audible approval of a signature field, the audio signature management system can generate signed digital documents including a verified audio signature. Further, by embedding an audio file including the approval of the audio signature, the audio signature management system can generate and store high-fidelity information corresponding to the signature. Additionally, by verifying the audio signature with biometric data corresponding to the voice in the audio response, the audio signature management system provides improved accuracy over existing systems with regard to verifying the signor.

Additionally, as mentioned above, existing systems rely on input devices and display systems to perform an electronic signature process. The systems described herein overcome these technical limitations by providing a systems to receive an accurate and secure digital signature without relying on visual-based input devices and display systems. To illustrate, the audio signature management system can generate signatures by generating a field prompt audio file and providing it to a client device to request an audio signature. By generating an audio signature and associated metadata, the audio signature management system can provide secure and accurate signatures based on verbal affirmations from users. Thus, the system provides improved flexibility in a variety of contexts including for users with physical disabilities or visual impairment who are still be able to provide verbal approval for a signature. Accordingly, the audio signature management system can provide signatures in a variety of contexts that existing signature systems cannot.

As illustrated by the foregoing discussion, the present disclosure utilizes a variety of terms to describe features and advantages of the audio signature management system. Additional detail is now provided regarding the meaning of such terms. For example, as used herein, the term “field prompt audio file” refers to a playable audio corresponding to a digital document. In particular, the term field prompt audio file can refer to an audio file that requests a response to a blank field in a digital document. To illustrate, a field prompt audio file can include an audio file requesting information for a blank field in a digital document, an audio file requesting a user's choice for a multiple choice question in a digital document, an audio file requesting approval to initial a digital document, and/or an audio file requesting approval to sign a digital document. Relatedly, as used herein, the term “signable field” refers to a portion of a digital document designated for a signature. In one or more embodiments, a signable field is a field within a digital document that corresponds to a signature and/or initials.

Further, as used herein, the term “audio response” refers to sounds received in response to a field prompt audio file. In particular, the term audio response can include a verbal response from a user captured by a client device and transmitted to the audio signature management system. To illustrate, an audio response can include audible approval or audible denial in response to a field prompt audio file.

As used herein, the term “digital signature,” “electronic signature,” or “signature” refers to any distinctive mark intended as a form of identification or authorization in an electronic document. In particular, the term “signature” can include any digital recording, digital drawing, point, line, curve, or image that an individual or entity intends to adopt as a form of identification or authorization. For example, an individual may often choose to adopt as their “signature” a distinctive drawing of the individual's name, title, initials, or moniker entered by a computer input device.

Relatedly, as used herein, the term “audio signature” refers to a digital signature associated with audible approval. For example, in one or more embodiments, an audio signature is associated with an authenticated audio clip approving the signature for a particular signable field. Additionally, as used herein, the term “non-verbal digital signature” refers to any signature not approved audibly or verbally. For example, a non-verbal digital signature can include a signature typed, selected with a mouse or trackpad, or drawn with a touch screen.

Also, as used herein, the term “authenticated audio clip” refers to a recording that has been verified in some way. In particular, the term authenticated audio clip can include a recording of an audio response including audible approval for signing a signable field within a digital document. Further, in one or more embodiments, an authenticated audio clip can include a recording that has been verified, including by a third-party, based on a hash and/or hashing algorithm. Also, in one or more embodiments, an authenticated audio clip includes a recording of a voice that has been verified to match biometric data corresponding to a particular user account.

Further, as used herein, the term “biometric data” refers to biological measurements or physical characteristics used to identify individuals. In particular, the term biometric data can include data corresponding to the identifiable components of a human voice. In one or more embodiments, biometric data includes analysis of a voice recording from a biometric algorithm. In some embodiments, biometric data is associated with a user account and/or user device.

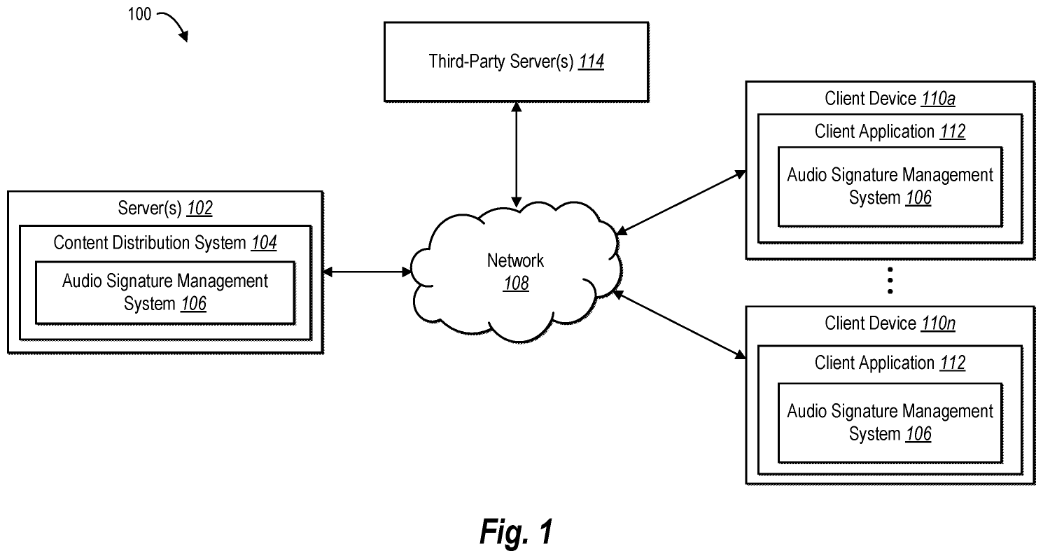

Additional detail will now be provided in relation to illustrative figures portraying example embodiments and implementations of the persona group system. For example, FIG. 1 illustrates a schematic diagram of an exemplary system 100 in which an audio signature management system 106 operates. As illustrated in FIG. 1, the system 100 includes a server(s) 102, a network 108, client devices 110a-110n, and a third-party server(s) 114.

Although the system 100 of FIG. 1 is depicted as having a particular number of components, the system 100 is capable of having any number of additional or alternative components (e.g., any number of servers, client devices, third-party servers, or other components in communication with the audio signature management system 106 via the network 108). Similarly, although FIG. 1 illustrates a particular arrangement of the server(s) 102, the network 108, the client devices 110a-110n, and the third-party server(s) 114, various additional arrangements are possible.

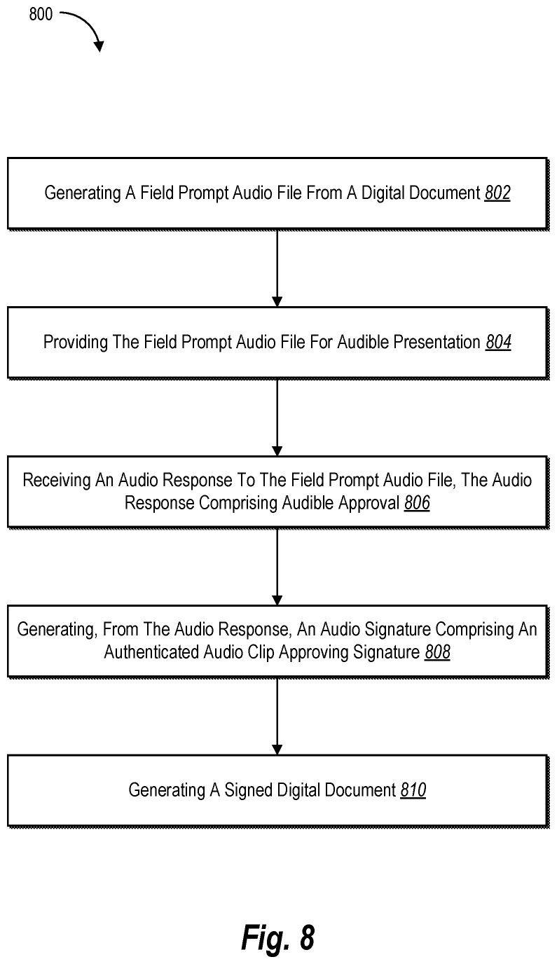

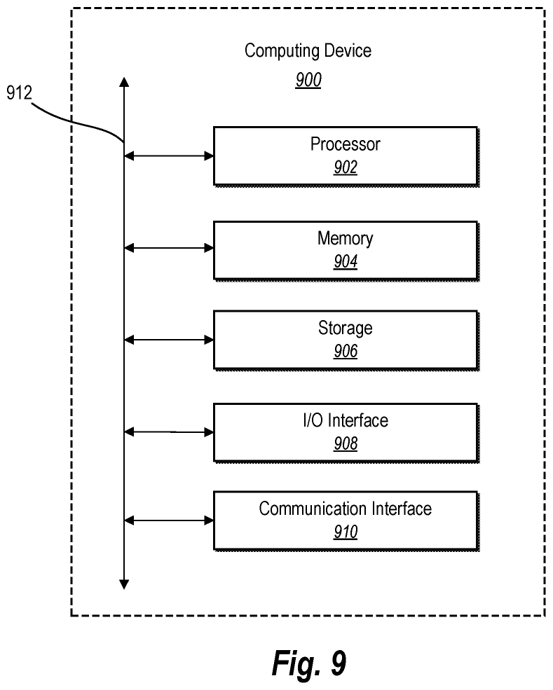

The server(s) 102, the network 108, the client devices 110a-110n, and the third-party server(s) 114 are communicatively coupled with each other either directly or indirectly (e.g., through the network 108 discussed in greater detail below in relation to FIG. 8). Moreover, the server(s) 102, the client devices 110a-110n, and the third-party server(s) 114 include one or more of a variety of computing devices (including one or more computing devices as discussed in greater detail with relation to FIG. 9).

As mentioned above, the system 100 includes the server(s) 102. In one or more embodiments, the server(s) 102 generates, stores, receives, and/or transmits data including digital data related to digital documents, field prompt audio files, audio responses, and/or digital signatures. In one or more embodiments, the server(s) 102 comprises a data server. In some implementations, the server(s) 102 comprises a communication server or a web-hosting server.

In one or more embodiments, the content distribution system 104 manages the distribution of digital content to client devices (e.g., the client devices 110a-110n). For example, in some instances, the content distribution system 104 distributes and/or manages digital documents. In some implementations, the content distribution system 104 distributes digital documents for display or for audio presentation via one or more digital platforms that are accessed by the client devices 110a-110n.

In one or more embodiments, the third-party server(s) 114 interacts with the audio signature management system 106, via the server(s) 102, over the network 108. For example, in some implementations, the third-party server(s) 114 hosts a digital platform that performs and/or verifies hashes for digital signatures. Further, in some cases, the third-party server(s) 114 interacts with the client devices 110a-110n and provides data regarding digital signatures, including audio signatures, regarding the audio signature management system 106.

Additionally, in one or more embodiments, the client devices 110a-110n include computing devices that access digital platforms and/or display digital content. For example, the client devices 110a-110n include smartphones, tablets, desktop computers, laptop computers, head-mounted-display devices, or other electronic devices. The client devices 110a-110n include one or more applications (e.g., the client application 112) that access digital platforms and/or display digital content, including digital documents. For example, in one or more embodiments, the client application 112 includes a software application installed on the client devices 110a-110n. Additionally, or alternatively, the client application 112 includes a web browser or other application that accesses a software application hosted on the server(s) 102 (and supported by the content distribution system 104).

To provide an example implementation, in one or more embodiments, the audio signature management system 106 on the server(s) 102 supports the audio signature management system 106 on the client device 110n. For instance, in some cases, the audio signature management system 106 on the server(s) 102 identifies a field prompt audio file corresponding to a digital document for audio presentation to the client device 110n. The audio signature management system 106 then, via the server(s) 102, communicates the field prompt audio file to the client device 110n. In some embodiments, based on playing the field prompt audio file, the audio signature management system 106 on the client device 110n receives and transmits an audio response. In some cases, the audio signature management system 106 on the client device 110n further receives and displays the digital document or a signed digital document.

The audio signature management system 106 is able to be implemented in whole, or in part, by the individual elements of the system 100. Indeed, although FIG. 1 illustrates the audio signature management system 106 implemented with regard to the server(s) 102, different components of the audio signature management system 106 are able to be implemented by a variety of devices within the system 100. For example, in some cases, one or more (or all) components of the audio signature management system 106 are implemented by a different computing device (e.g., one of the client devices 110a-110n) or a separate server from the server(s) 102 hosting the content distribution system 104 (e.g., the third-party server(s) 114). Indeed, as shown in FIG. 1, the client devices 110a-110n include the audio signature management system 106. Additionally, in some embodiments, one or more components of the of the client devices 110a-110n are implemented on the server(s) 102. To illustrate, in one or more embodiments, the server(s) 102 implement the client application 112 utilizing voice commands received via a telephone call from one of the client devices 110a-110n. Example components of the audio signature management system 106 will be described below with regard to FIG. 9.

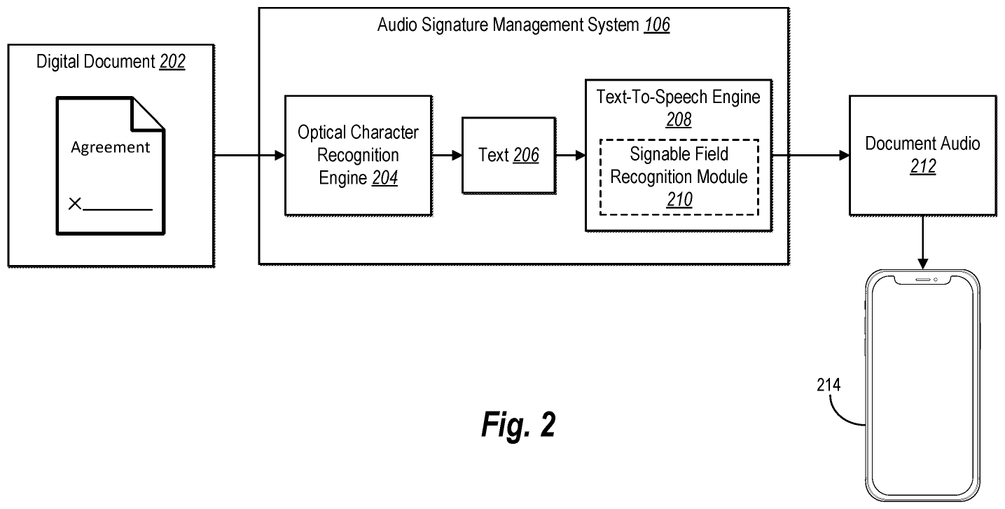

As discussed above, the audio signature management system 106 can generate document audio including generating a field prompt audio file. More specifically, the audio signature management system 106 can generate a field prompt audio file utilizing an optical character recognition engine and a text-to-speech engine. FIG. 2 illustrates an example process for generating and providing a field prompt audio file to a client device.

As shown in FIG. 2, the audio signature management system 106 receives a digital document 202. In one or more embodiments, the digital document 202 is a .pdf file, a .doc file, a .docx file, a .txt file, a .jpeg file, or another document including text. In some embodiments, the digital document 202 includes one or more fillable fields corresponding to signatures, initials, or other fillable information. In one or more embodiments, the digital document 202 includes metadata corresponding to the fillable fields.

In some embodiments, the audio signature management system 106 receives the digital document 202 from a client device. In addition, or in the alternative, the audio signature management system 106 can retrieve the digital document 202 from a database or other repository. Further, in some embodiments, the audio signature management system 106 can receive the digital document 202 from a third-party system based on a request from a client device.

As shown in FIG. 2, in one or more embodiments, the audio signature management system 106 provides the digital document 202 to an optical character recognition engine 204. In one or more embodiments, the audio signature management system 106 utilizes the optical character recognition engine 204 to generate text from the digital document 202. In some embodiments, the optical character recognition engine 204 scans the digital document 202 and converts it to binary data.

Accordingly, the optical character recognition engine 204 can analyze the digital document 202 by classifying content from the digital document as either background or text from the digital document 202. Thus, in one or more embodiments, the optical character recognition engine 204 generates text 206 from the digital document 202 utilizing pattern matching and feature extraction on the portions identified as text. That is, the optical character recognition engine 204 can determine what portions of the digital document 202 include text and then identify, from those portions, what characters the text 206 includes.

As also shown in FIG. 2, the audio signature management system 106 provides the text 206 to a text-to-speech engine 208. In one or more embodiments, the text-to-speech engine 208 converts the text 206 to phonemic representations. Further, in some embodiments, the text-to-speech engine 208 converts the phonemic representations to waveforms that can be output as sounds. The audio signature management system 106 can save these sounds as a document audio 212, and more specifically as a field prompt audio file.

In one or more embodiments, the text-to-speech engine 208 generates the field prompt audio file to include an audible reading of the text 206 from the digital document 202. Further, in some embodiments, the text-to-speech engine 208 generates the field prompt audio file to include an audible prompt explaining one or more signable fields and/or one or more fillable fields in the digital document 202. Additionally, the field prompt audio file can include a request to verbally approve, deny, or provide information corresponding to the field.

Additionally, in one or more embodiments, the text-to-speech engine 208 includes a signable field recognition module 210 that identifies signable fields and/or fillable fields in the digital document 202. In some embodiments, the signable field recognition module 210 identifies multiple underscores or other repeated characters from the text 206 as a signable or fillable field. In addition, in one or more embodiments, the signable field recognition module 210 utilizes metadata from the digital document 202 that flags signable fields or fillable fields.

In some embodiments, the signable field recognition module 210 also adds text from the metadata associated with signable fields to the text 206 to generate the document audio 212. As mentioned above, the text-to-speech engine 208 can generate a field prompt audio file including an audible request to provide verbal approval, denial, or information corresponding to a signable or fillable field in the digital document. In one or more embodiments, the audio signature management system 106 utilizes text from the metadata to generate the audible request.

In addition, or in the alternative, the audio signature management system 106 can automatically select language for a field prompt audio file. To illustrate, in one or more embodiments, the audio signature management system 106 can utilize the text 206 to select an audible prompt that best matches the context. More specifically, the audio signature management system 106 can utilize a natural language processing model on the text preceding a signable field or a fillable field to determine a best match among a set of audible prompts for verbal approval, denial, or information. For example, the audio signature management system 106 can identify key words such as “sign,” or “signature,” to select a prompt that asks for approval to sign. In this example, the audio signature management system 106 can select an audio prompt with the text “Do you agree to sign this field based on the above text of this document?” for insertion into the field prompt audio file at the point where the corresponding field is in the digital document 202.

Additionally, in one or more embodiments, the audio signature management system 106 can generate the field prompt audio file to request specific language approving a field. For example, the audio signature management system 106 can generate the field prompt audio file to include audio information reading “Please state your name and that you agree to the above terms.” Then, when processing an audio clip provided in response, the audio signature management system 106 can determine whether the audio response includes both approval and the correct name associated with the user account corresponding to the user device. For example, the audio signature management system 106 can identify the text “My name is John Smith and I agree to these terms,” “I am John Smith and I agree to the terms,” or a similar identifier and approval.

In another example, the audio signature management system 106 can utilize keywords such as “address,” “date,” or “relationship to applicant,” to select a prompt related to a fillable field for information. To illustrate, based on determining that a field is immediately preceded by the text “phone number,” the audio signature management system 106 can select an audio prompt with the text “Please provide your phone number,” at the point where the corresponding field is in the digital document 202.

Additionally, in one or more embodiments, the signable field recognition module 210 can recognize various types of fields. For example, the signable field recognition module 210 can identify a drop-down menu and the text associated with the different options in the drop-down menu, a multiple choice question its associated options, and checkboxes with their associated text. Based on identifying the drop-down menu and its corresponding options, in one or more embodiments, the audio signature management system 106 generates an audio prompt presenting the options. For example, the audio signature management system 106 can determine a drop-down menu including options for months of the year immediately following the text “Current Month,” in the digital document. Based on identifying the options of drop-down menu, and based on pe, the audio signature management system 106 can identify an audio prompt corresponding to the question type, such as “Please provide the current month.”

In another example, the audio signature management system 106 can generate a custom audio prompt based on the options for a multiple choice question or a drop-down menu. To illustrate, the signable field recognition module 210 can incorporate the text into a template for an audio prompt. For example, the signable field recognition module 210 can identify a multiple choice question with selectable options beside the text “signing for self” and “signing on behalf of someone else.” Based on the signable field recognition module 210 identifying the text beside the selectable options, the audio signature management system 106 can select a multiple choice audio prompt template and provide the identified information to generate a custom audio prompt. For example, the audio signature management system 106 can select a multiple choice template including the text “Which applies to you?” and then providing the identified options from the digital document 202. In this example, the audio signature management system 106 can generate a custom audio prompt including audio reading “Which applies to you? Signing for self or signing on behalf of someone else?”

Further, the audio signature management system 106 can generate custom field prompt audio files and/or custom portions of field prompt audio files for a variety of contexts, field types, and option types. To illustrate, the audio signature management system 106 can utilize a signable field recognition module 210 to identify various field types and various information corresponding to the fields. Further, the audio signature management system 106 can utilize a variety of templates and match those templates with a variety of keywords or other text identified from a digital document.

As shown in FIG. 2, the audio signature management system 106 can provide the document audio 212 including field prompt audio files to a client device 214 for presentation and signing. In one or more embodiments, the audio signature management system 106 provides instructions for playback of the field prompt audio files to the client device 214. Though FIG. 2 illustrates a single client device 214, it will be appreciated that the audio signature management system 106 can provide field prompt audio files to a variety of client devices, including as requested by an administrator device and/or a client device.

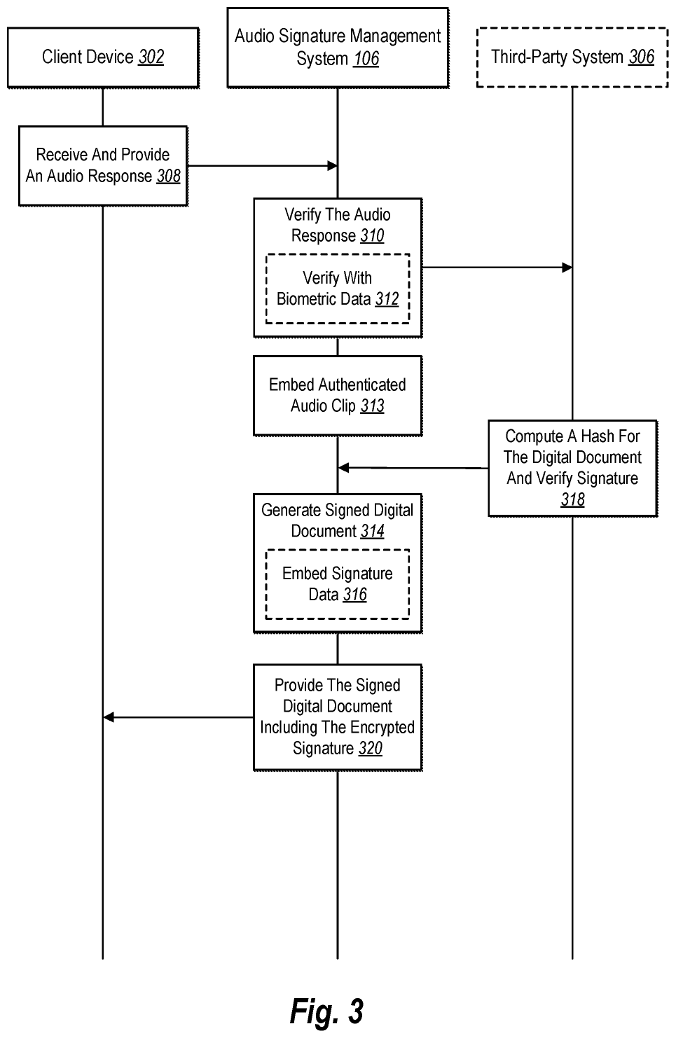

As mentioned above, upon providing the field prompt audio file to a client device, the audio signature management system 106 can receive audio responses via the client device. Further, in one or more embodiments, the audio signature management system 106 generates and applies audio signatures based on the received audio responses. FIG. 3 illustrates an example process for generating audio signatures and applying the signatures to generated signed digital documents.

As mentioned above, client devices can play the field prompt audio file and detect audio responses. Further, as shown in FIG. 3, a client device 302 can perform an act 308 of receiving and providing an audio response. More specifically, in one or more embodiments, the client device 302 detects and records an audio response during and/or after presentation of a field prompt audio file. Further, the client device 302 provides the audio response to the audio signature management system 106. To illustrate, in one or more embodiments, the client device 302 records and sends an audio clip to the audio signature management system 106.

In one or more embodiments, the audio signature management system 106 performs an act 310 of verifying the audio response. To illustrate, the audio signature management system 106 can authenticate the audio response by converting speech from the audio clip into text utilizing a speech-to-text engine. Additionally, the audio signature management system 106 can utilize a natural language processing model to identify approval, refusal, or information from the audio clip.

Further, in one or more embodiments, the audio signature management system 106 performs an optional step 312 of verifying the audio clip utilizing biometric data. More specifically, in some embodiments, the audio signature management system 106 identifies biometric data associated with a user account corresponding to the client device 302. Accordingly, in one or more embodiments, the audio signature management system 106 compares the audio clip received from the client device 302 to the biometric data to determine whether the voice in the audio clip is the voice that corresponds to the biometric data.

More specifically, in one or more embodiments, the biometric data includes data corresponding to the identifiable components of a human voice associated with the user account. In one or more embodiments, the audio signature management system 106 generates the biometric data by analyzing audio clips provided by a client device for biometric data gathering. Accordingly, in one or more embodiments, the audio signature management system 106 verifies the biometric data utilizing a biometric algorithm to determine whether the voice in an audio clip has the same identifiable components as the voice associated with the biometric data.

Upon interpreting and authenticating the audio response, in one or more embodiments, the audio signature management system 106 utilizes the authenticated audio clip to generate an audio signature. More specifically, in one or more embodiments, the audio signature management system 106 utilizes a private encryption key and an encryption algorithm associated with the client device 302 to encrypt the audio signature.

As shown in FIG. 3, in one or more embodiments, the audio signature management system 106 performs an act 313 of embedding an authenticated audio clip. To illustrate, in some embodiments, upon verifying the audio response, the audio signature management system 106 can generate an authenticated audio clip by clipping the portion of a recording that includes the audible approval of a signature. Accordingly, in some embodiments, the audio signature management system 106 embeds the authenticated audio clip including the audible approval into the document. For example, the audio signature management system 106 can embed the authenticated audio clip into the metadata of a PDF.

Further, as shown in FIG. 3, in one or more embodiments, the audio signature management system 106 provides the audio signature to a third-party system 306. In some embodiments, the third-party system 306 performs an act 318 of computing a hash for the digital document and verifying the signature. In addition, or in the alternative, in one or more embodiments, the audio signature management system 106 performs the act 318. To illustrate, in one or more embodiments, the third-party system 306 utilizes a public encryption key associated with the client device 302 to decrypt the audio signature. Further, in some embodiments, the third-party system 306 utilizes the same hashing algorithm that generated the audio signature to generate a new hash of the same authenticated audio clip. Accordingly, the third-party system 306 can compare its computation to the audio signature to verify that the audio signature originated from the client device 302 and has not been tampered with.

Additionally, as shown in FIG. 3, the audio signature management system 106 can utilize the audio signature to generate a signed digital document. In one or more embodiments, the audio signature management system 106 applies a visual representation of the audio signature to the digital document. In some embodiments, the audio signature management system 106 applies an icon or text associated with the client device 302 as a visual representation of the audio signature. In addition, in one or more embodiments, the audio signature management system 106 includes an indication that the signature is an audio signature and/or was received verbally from the signor.

Further, in some embodiments, the audio signature management system 106 applies information from the audio clip to fillable fields in the signed digital document to generate a signed digital document, as shown in act 314 of FIG. 3. As mentioned above, in one or more embodiments the audio signature management system 106 utilizes natural language processing to identify verbal information from an authenticated audio clip and convert the verbal information into text. The audio signature management system 106 can fill the identified fillable field with the text.

As also shown in FIG. 3, in one or more embodiments, the audio signature management system 106 performs an optional act 316 of embedding signature data into the signed digital document. More specifically, in one or more embodiments, the audio signature management system 106 embeds the authenticated audio clip into the signed digital document. In various embodiments, the audio signature management system 106 can embed the authenticated audio clip into the signed digital document as a variety of audio file types.

Additionally, as shown in FIG. 3, the audio signature management system 106 can perform an act 320 of providing the signed digital document including the audio signature. In one or more embodiments, the audio signature management system 106 provides the signed digital document back to the client device 302. Further, in various embodiments, the audio signature management system 106 can also provide the signed digital documents to other client devices, one or more client devices selected by the client device 302.

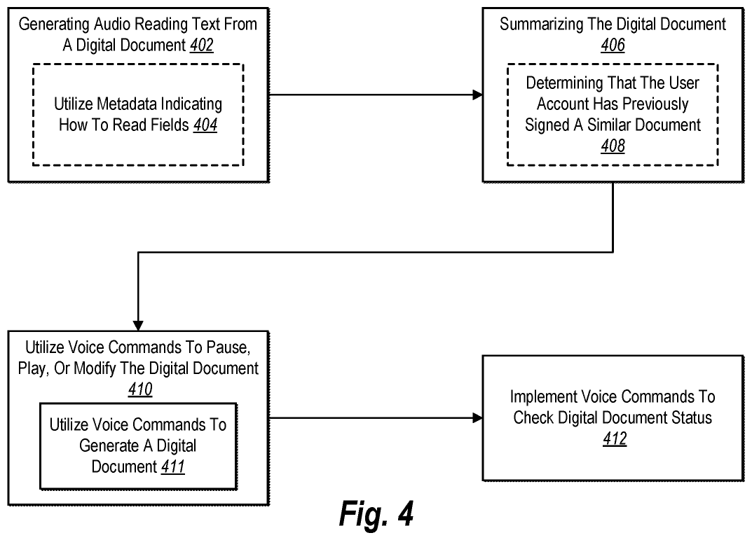

As mentioned above, in one or more embodiments, the audio signature management system 106 can modify the playback of a field prompt audio file. FIG. 4 illustrates a process for modifying the playback of a field prompt audio file. As shown in FIG. 4, in one or more embodiments, the audio signature management system 106 performs an act 402 of generating audio reading text from a digital document. As mentioned above with regard to FIG. 2, the audio signature management system 106 can utilize a text-to-speech engine to generate a field prompt audio file reading text from a digital document.

The audio signature management system 106 can also perform an optional act 404 of utilizing metadata indicating how to read fields. As mentioned above with regard to FIG. 2, the audio signature management system 106 can utilize a signable field recognition module to determine where signable fields in a digital document are located. Further, the audio signature management system 106 can add text from the metadata associated with signable fields to the text 206 to generate the field prompt audio file. In one or more embodiments, the audio signature management system 106 generates field prompt audio file including an audible request to provide verbal approval, denial, or information corresponding to a signable or fillable field in the digital document. More specifically, in one or more embodiments, the audio signature management system 106 utilizes text from the metadata to generate the audible request.

As also shown in FIG. 4, in one or more embodiments, the audio signature management system 106 can perform an act 406 of summarizing the digital document. In one or more embodiments, the audio signature management system 106 can retrieve a summary from metadata associated with the digital document. In addition, or in the alternative, the audio signature management system 106 can generate the summary using headings or keywords from the digital document. To illustrate, the audio signature management system 106 can utilize a natural language processing model to identify the headings or keywords.

Further, in one or more embodiments, the audio signature management system 106 can insert the headings or keywords into a summary template. For example, the audio signature management system 106 can generate a summary from a template reading “This is a [agreement type] from [document drafter] related to [list headings and keywords].” In this example, the summary could read “This is a non-disclosure agreement from ABC Incorporated related to work to be completed in January 2023.”

Additionally, as shown in FIG. 4, the audio signature management system 106 can perform an optional act 408 of determining that the user account has previously signed a similar document. To illustrate, in one or more embodiments, the audio signature management system 106 can compare digital documents and their metadata, including the drafter or sender of a digital document. In one or more embodiments, the audio signature management system 106 can determine a percentage similarity and utilize a similarity threshold to mark the agreements as similar, such as 75%, 90%, etc.

In one or more embodiments, when generating the summary of the digital document, the audio signature management system 106 can include reference to the prior similar documents. Further, the audio signature management system 106 can include a summary of the differences between the similar documents. To illustrate, the audio signature management system 106 can apply a natural language processing model to the portions of the document that are different and identify dissimilar headings or keywords. Accordingly, in one or more embodiments, the audio signature management system 106 can include the dissimilar headings and keywords in the summary. For example, the audio signature management system 106 can generate a summary indicating “This document is similar to the NDA from ABC Incorporated that you signed last month. However, it specifies work to be completed in February 2023.”

In some embodiments, the audio signature management system 106 can provide the summary in response to receiving a verbal request from a user to provide the summary. More specifically, before or during playback of the audio signature management system 106, the audio signature management system 106 can receive an audio clip from the client device including verbal information stating, “Please summarize the agreement,” and can provide the summary in response to the request. In addition, or in the alternative, the audio signature management system 106 can provide a summary of a digital document in response to determining that the digital document is similar to one or more digital documents that the user account associated with the client device has already signed.

As also shown in FIG. 4, the audio signature management system 106 can perform an act 410 of utilizing voice commands to pause, play, or modify the digital document. In one or more embodiments, the audio signature management system 106 can receive voice commands corresponding to the digital document from the client device 302. In some embodiments, the audio signature management system 106 can modify the playback of the field prompt audio file based on these voice commands. For example, the audio signature management system 106 can pause, play, rewind, fast-forward, skip sections, or otherwise modify the playback of the field prompt audio file.

Additionally, in one or more embodiments, the audio signature management system 106 can receive voice commands requesting changes to the digital document. In some embodiments, the audio signature management system 106 can insert text from the voice command as redline, as a comment, or directly into the digital document. In addition, or in the alternative, the audio signature management system 106 can identify a reference to a pre-saved clause in the voice command. Based on this reference, the audio signature management system 106 can insert the pre-saved clause into the digital document.

In one or more embodiments, the audio signature management system 106 can store pre-saved clauses in a database or other repository. In some embodiments, the audio signature management system 106 can associate the pre-saved clauses with titles and/or keywords that it can match voice commands with to retrieve the pre-saved clauses. For example, the audio signature management system 106 can receive a voice command of, “Insert a severability clause here.” In response to receiving this command, the audio signature management system 106 can query a pre-saved clause database for “severability” and insert a clause titled “Severability Clause.”

In one or more embodiments, the audio signature management system 106 can insert a clause or modification into the agreement at a point indicated in the voice command. To illustrate, the audio signature management system 106 can identify an insertion point by identifying key words utilizing a natural language processing model. For example, the audio signature management system 106 can identify keywords such as “here,” “after this section,” “before this section,” “at the beginning of the document,” etc. Thus, the audio signature management system 106 can insert the modification or pre-saved clause at a location in the digital document based on the voice command.

Additionally, as shown in FIG. 4, the audio signature management system 106 can perform an act 411 of utilizing voice commands to generate a digital document. To illustrate, the audio signature management system 106 can convert recorded speech into text for a digital document. Additionally, the audio signature management system 106 can insert pre-saved clauses into a new document as described above with regard to modifications to an existing digital document.

For example, the audio signature management system 106 can receive a voice command of “Create a document from my photo release template with weekend pricing and a copyright assignment clause and send it to John Smith.” In response, the audio signature management system 106 can generate a photo release agreement with the requested weekend pricing and a copyright assignment clause. Additionally, the audio signature management system 106 can send the generated document to a client device associated with a user account for John Smith.

Further, as shown in FIG. 4, in one or more embodiments, the audio signature management system 106 can perform an act 412 of implementing voice commands to check digital document status. For example, the audio signature management system 106 can check on and report as to whether a digital document has been signed, has been sent, has been viewed, etc.

To illustrate, in one or more embodiments, the audio signature management system 106 can receive a voice command via a client device including “Has my contract been signed by everyone?” Based on analyzing the content of the voice command, the audio signature management system 106 can identify signatures applied to a digital document associated with the client device corresponding to the user account. For example, the audio signature management system 106 can determine that four out of five signatures for the digital document have been received. Then, the audio signature management system 106 can generate and provide an audio clip including the text “Four out of five signors have signed your contract. You are still waiting on the signature of John Smith.” In an additional example, the audio signature management system 106 can receive and provide responses to audio prompts such as, “What's the current status of Contract Five?”; “Is the rental agreement complete?”; and “What are all the documents signed in the last 10 days?” In response to receiving an audio prompt, the audio signature management system 106 can generate a query that it then compares against signature documents associated with a user account that are in process or processed.

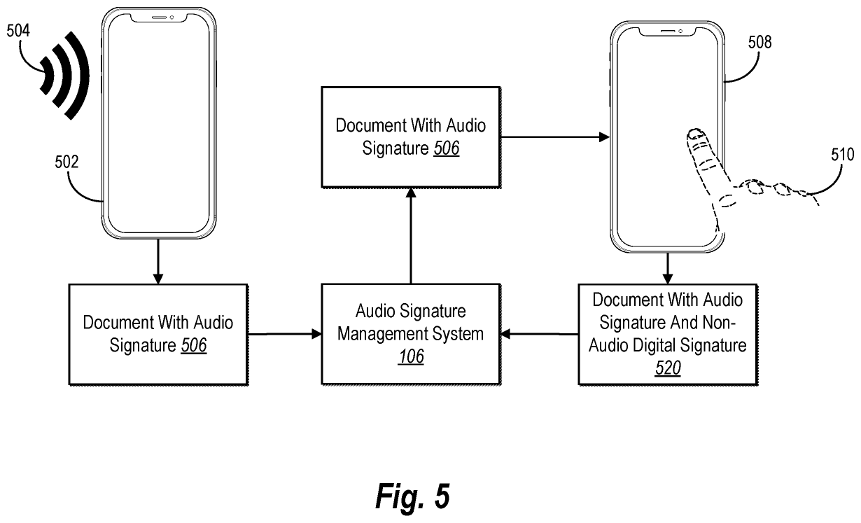

In one or more embodiments, the audio signature management system 106 can apply various signature types to a digital document. FIG. 5 illustrates an example process for managing digital documents with audio signatures and non-audio digital signatures. More specifically, as shown in FIG. 5, in one or more embodiments, the audio signature management system 106 can generate an audio signature based on a client device 502 detecting an audio response 504. Accordingly, the audio signature management system 106 can generate a document with audio signature 506.

As shown in FIG. 5, the audio signature management system 106 can provide the document with audio signature 506 to a client device 508. As also shown in FIG. 5, the client device 508 can detect a user interaction 510 signing the document with audio signature 506 utilizing a touch screen. Based on the user interaction 510, the audio signature management system 106 can generate and apply a non-audio digital signature to the document with audio signature 506. Accordingly, the audio signature management system 106 can generate a document with audio signature and non-audio digital signature 520.

In one or more embodiments, the audio signature management system 106 can receive, store, modify, send, and/or otherwise manage the document with audio signature and non-audio digital signature 520. For example, in one or more embodiments, the audio signature management system 106 can provide the document with audio signature and non-audio digital signature 520 to an additional client device for an additional signature. Accordingly, the audio signature management system 106 can integrate various signature types into a single digital document.

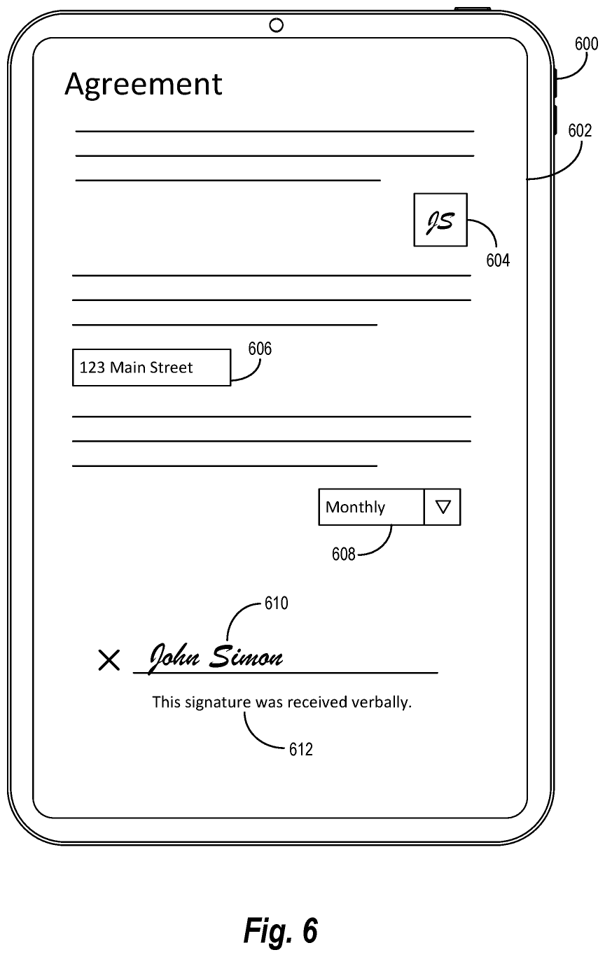

As mentioned above, in one or more embodiments, the audio signature management system 106 can generate a signed digital document including a visual representation of an audio signature. FIG. 6 illustrates an example client device 600 presenting a signed digital document graphical user interface 602. As shown in FIG. 6, the signed digital document graphical user interface 602 includes a digital document with fields 604-610.

More specifically, the audio signature management system 106 can fill the fields 604-610 in the signed digital document graphical user interface 602. As mentioned above, the audio signature management system 106 can fill an initial field such as the field 604 and a signature field such as the field 610 based on receiving an audio response including audible approval for initialing or signing the field. Further, the audio signature management system 106 can fill a fillable field such as the fields 606-608 with information from an audio response.

For example, the field 606 includes the text “123 Main Street.” Additionally, the field 608 includes the text “Monthly” selected from a drop-down menu. However, as discussed above, the audio signature management system 106 can fill a variety of information into a variety of types of fields based on audio responses.

As shown in FIG. 6, the audio signature management system 106 generates a visual representation of the audio signature for the field 610. In one or more embodiments, the audio signature management system 106 generate the visual representation of the audio signature based on user settings and/or user selection of a representative signature. In addition, or in the alternative, the audio signature management system 106 can generate visual representation of the audio signature by rendering the name of the user associated with the client device 600 in a font resembling handwritten script.

As also shown in FIG. 6, the audio signature management system 106 can generate an audio indication 612. More specifically, as shown in FIG. 6, the audio indication 612 includes the text, “This signature was received verbally.” However, it will be appreciated that the audio signature management system 106 can generate an indication that the audio signature was received by voice in a variety of configurations. As shown in FIG. 6, the audio signature management system 106 can apply the indication that the audio signature was received by voice to the signed digital document near the digital signature and/or the field 610.

Each of the components 702-712 of the audio signature management system 106 can include software, hardware, or both. For example, the components 702-712 can include one or more instructions stored on a computer-readable storage medium and executable by processors of one or more computing devices, such as a client device or server device. When executed by the one or more processors, the computer-executable instructions of the audio signature management system 106 can cause the computing device(s) to perform the methods described herein. Alternatively, the components 702-712 can include hardware, such as a special-purpose processing device to perform a certain function or group of functions. Alternatively, the components 702-712 of the audio signature management system 106 can include a combination of computer-executable instructions and hardware.

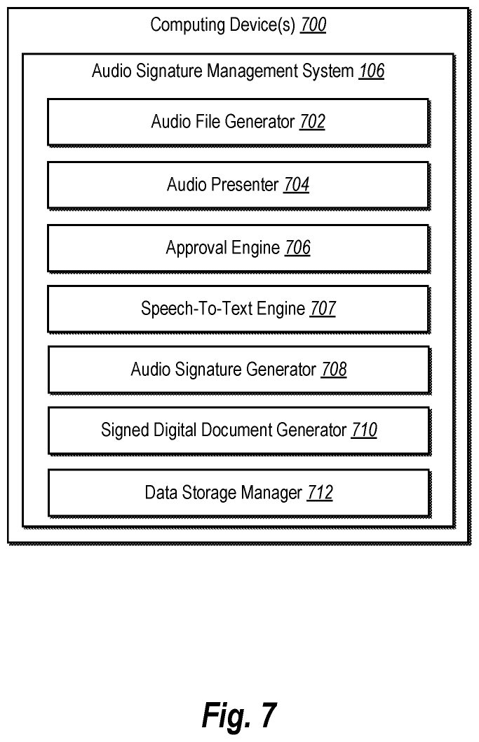

Furthermore, the components 702-712 of the audio signature management system 106 may, for example, be implemented as one or more operating systems, as one or more stand-alone applications, as one or more modules of an application, as one or more plug-ins, as one or more library functions or functions that may be called by other applications, and/or as a cloud-computing model. Thus, the components 702-712 may be implemented as a stand-alone application, such as a desktop or mobile application. Furthermore, the components 702-712 may be implemented as one or more web-based applications hosted on a remote server. The components 702-712 may also be implemented in a suite of mobile device applications or “apps.” As shown in FIG. 7, the audio signature management system 106 includes an audio file generator 702, an audio presenter 704, an approval engine 706, a speech-to-text engine 707, an audio signature generator 708, a signed digital document generator 710, and a data storage manager 712.

As shown in FIG. 7, the computing device(s) 700 includes the audio file generator 702. In one or more embodiments, the audio file generator 702 generates field prompt audio files corresponding to digital documents. In some embodiments, the audio file generator 702 utilizes an optical character recognition algorithm, a speech-to-text engine, a text-to-speech engine, and/or metadata from digital documents to generate audio files.

Additionally, as shown in FIG. 7, the computing device(s) 700 includes the audio presenter 704. In one or more embodiments, the audio presenter 704 distributes field prompt audio files to client devices. Additionally, in one or more embodiments, the audio presenter provides instructions for playing and ordering presentation of audio files.

Further, as shown in FIG. 7, the computing device(s) 700 includes the approval engine 706. In some embodiments, the approval engine 706 receives audio response. In one or more embodiments, the approval engine 706 captures authenticated audio clips including audio responses. The approval engine 706 can analyze audio responses to identify content of the audio response approving, denying, or providing information corresponding to fields in a digital document. Additionally, in some embodiments, the approval engine 706 authenticates audio clips utilizing biometric data.

Additionally, as shown in FIG. 7, the client device(s) 700 includes the speech-to-text engine 707. In one or more embodiments, the speech-to-text engine 707 converts audio files including audible responses to text. Accordingly, in some embodiments, the audio signature management system 106 utilizes the text to generate signatures, apply commands for navigating among documents, and/or generate documents. Thus, the approval engine 706, the audio signature generator 708, and/or the signed digital document generator 710 can utilize the text from the speech-to-text engine 707.

Also, as shown in FIG. 7, the computing device(s) 700 includes the audio signature generator 708. In one or more embodiments, the audio signature generator 708 applies a visual signature to a digital document. Additionally, in some embodiments, the audio signature generator 708 embeds an authenticated audio clip corresponding to an audio signature within the digital document. In one or more embodiments, the audio signature generator 708 provides the audio signature to a third-party system to perform a hash and/or performs a hash to encrypt the audio signature.

Additionally, as shown in FIG. 7, the computing device(s) 700 includes the signed digital document generator 710. In some embodiments, the signed digital document generator 710 fills fields in a digital document based on audio responses to field prompt audio files. To illustrate, in one or more embodiments, the signed digital document generator 710 applies a visual signature to a digital document including an indication that the signature corresponds to a verbal affirmation.

Further, as shown in FIG. 7, the computing device(s) 700 includes the data storage manager 712. The data storage manager 712 maintains data for the audio signature management system 106. The data storage manager 712 (e.g., via one or more memory devices) maintains data of any type, size, or kind, as necessary to perform the functions of the audio signature management system 106. For example, the data storage manager 712 includes digital documents, signed digital documents, field prompt audio files, biometric data, and other data.

FIGS. 1-7, the corresponding text, and the examples provide a number of different methods, systems, devices, and non-transitory computer-readable media of the audio signature management system 106. In addition to the foregoing, one or more embodiments can also be described in terms of flowcharts comprising acts for accomplishing a particular result, as shown in FIG. 8. FIG. 8 may be performed with more or fewer acts. Further, the acts may be performed in differing orders. Additionally, the acts described herein may be repeated or performed in parallel with one another or parallel with different instances of the same or similar acts.

As mentioned, FIG. 8 illustrates a flowchart of a series of acts 800 for generating a signed digital document by applying an audio signature in accordance with one or more embodiments. While FIG. 8 illustrates acts according to one embodiment, alternative embodiments may omit, add to, reorder, and/or modify any of the acts shown in FIG. 8. The acts of FIG. 8 can be performed as part of a method. Alternatively, a non-transitory computer-readable medium can comprise instructions that, when executed by one or more processors, cause a computing device to perform the acts of FIG. 8. In some embodiments, a system can perform the acts of FIG. 8.

As shown in FIG. 8, the series of acts 800 includes an act 802 for generating a field prompt audio file from a digital document. In particular, the act 802 can include generating a field prompt audio file from a digital document comprising a signable field. Specifically, the act 802 can include generate a field prompt audio file from a digital document comprising a signable field, wherein the field prompt audio file comprises audio prompting audible response to the signable field of the digital document. Further, in one or more embodiments, the act 802 includes providing the digital document to an optical character recognition engine to generate text, and providing the text to a speech engine to generate the field prompt audio file.

Additionally, the series of acts 800 includes an act 804 for providing the field prompt audio file for audible presentation. In particular, the act 804 can include providing the field prompt audio file for audible presentation by a client device.

Further, the series of acts 800 includes an act 806 for receiving an audio response to the field prompt audio file, the audio response comprising audible approval. In particular, the act 806 can include receiving an audio response to the field prompt audio file from the client device, the audio response comprising audible approval for signing the signable field within the digital document.

Also, the series of acts 800 includes an act 808 for generating, from the audio response, an audio signature comprising an authenticated audio clip approving signature. In particular, the act 808 can include generating, from the audio response, an audio signature comprising an authenticated audio clip approving signature of the signable field within the digital document. Specifically, the act 808 can include generating, based on determining that the audio response comprises the audible approval, an audio signature comprising an authenticated audio clip approving signature of the signable field within the digital document. In some embodiments, the act 808 includes identifying biometric data corresponding to a user account associated with the audio signature, and authenticating the audio response utilizing the biometric data.

Additionally, the series of acts 800 includes an act 810 for generating a signed digital document. In particular, the act 810 can include generating a signed digital document by applying the audio signature to the digital document. Specifically, the act 810 can include identifying an additional field in the digital document comprising one of a multiple choice question or a text field, providing an additional field prompt audio file comprising a prompt to give verbal information corresponding to the additional field, converting the verbal information to text, and wherein generating the signed digital document further comprises filling the additional field based on the text. Further, in one or more embodiments, the act 810 includes embedding the authenticated audio clip approving the signature into the signed digital document. Additionally, in some embodiments, the act 808 includes generating and applying an indication that the audio signature was received by voice to the signed digital document.

Also, in one or more embodiments, the series of acts 800 includes in response to generating the signed digital document, providing the signed digital document to an additional client device, receiving, from the additional client device, a non-verbal digital signature, and applying the non-verbal digital signature to the signed digital document.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed by a general-purpose computer to turn the general-purpose computer into a special purpose computer implementing elements of the disclosure. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. As used herein, the term “cloud computing” refers to a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In addition, as used herein, the term “cloud-computing environment” refers to an environment in which cloud computing is employed.

FIG. 9 illustrates a block diagram of an example computing device 900 that may be configured to perform one or more of the processes described above. One will appreciate that one or more computing devices, such as the computing device 900 may represent the computing devices described above (e.g., the server(s) 102, the client devices 110a-110n, the third-party server(s) 114, the client device 214, the client device 302, the client device 502, the client device 508, the client device 600, and/or the computing device(s) 700). In one or more embodiments, the computing device 900 may be a mobile device (e.g., a mobile telephone, a smartphone, a PDA, a tablet, a laptop, a camera, a tracker, a watch, a wearable device, etc.). In some embodiments, the computing device 900 may be a non-mobile device (e.g., a desktop computer or another type of client device). Further, the computing device 900 may be a server device that includes cloud-based processing and storage capabilities.

As shown in FIG. 9, the computing device 900 can include one or more processor(s) 902, memory 904, a storage device 906, input/output interfaces 908 (or “I/O interfaces 908”), and a communication interface 910, which may be communicatively coupled by way of a communication infrastructure (e.g., bus 912). While the computing device 900 is shown in FIG. 9, the components illustrated in FIG. 9 are not intended to be limiting. Additional or alternative components may be used in other embodiments. Furthermore, in certain embodiments, the computing device 900 includes fewer components than those shown in FIG. 9. Components of the computing device 900 shown in FIG. 9 will now be described in additional detail.

In particular embodiments, the processor(s) 902 includes hardware for executing instructions, such as those making up a computer program. As an example, and not by way of limitation, to execute instructions, the processor(s) 902 may retrieve (or fetch) the instructions from an internal register, an internal cache, memory 904, or a storage device 906 and decode and execute them.

The computing device 900 includes memory 904, which is coupled to the processor(s) 902. The memory 904 may be used for storing data, metadata, and programs for execution by the processor(s). The memory 904 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 904 may be internal or distributed memory.

The computing device 900 includes a storage device 906 includes storage for storing data or instructions. As an example, and not by way of limitation, the storage device 906 can include a non-transitory storage medium described above. The storage device 906 may include a hard disk drive (HDD), flash memory, a Universal Serial Bus (USB) drive or a combination these or other storage devices.

As shown, the computing device 900 includes one or more I/O interfaces 908, which are provided to allow a user to provide input to (such as user strokes), receive output from, and otherwise transfer data to and from the computing device 900. These I/O interfaces 908 may include a mouse, keypad or a keyboard, a touch screen, camera, optical scanner, network interface, modem, other known I/O devices or a combination of such I/O interfaces 908. The touch screen may be activated with a stylus or a finger.

The I/O interfaces 908 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 908 are configured to provide graphical data to a display for presentation to a user. The graphical data may be representative of one or more graphical user interfaces and/or any other graphical content as may serve a particular implementation.

The computing device 900 can further include a communication interface 910. The communication interface 910 can include hardware, software, or both. The communication interface 910 provides one or more interfaces for communication (such as, for example, packet-based communication) between the computing device and one or more other computing devices or one or more networks. As an example, and not by way of limitation, communication interface 910 may include a network interface controller (NIC) or network adapter for communicating with an Ethernet or other wire-based network or a wireless NIC (WNIC) or wireless adapter for communicating with a wireless network, such as a WI-FI. The computing device 900 can further include a bus 912. The bus 912 can include hardware, software, or both that connects components of computing device 900 to each other.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A method comprising:
generating a field prompt audio file from a digital document comprising a signable field;
providing the field prompt audio file for audible presentation by a client device;
receiving an audio response to the field prompt audio file from the client device, the audio response comprising audible approval for signing the signable field within the digital document;
generating, from the audio response, an audio signature comprising an authenticated audio clip approving signature of the signable field within the digital document; and
generating a signed digital document by applying the audio signature to the digital document.

2. The method of claim 1, wherein generating the field prompt audio file comprises:
providing the digital document to an optical character recognition engine to generate text; and
providing the text to a speech engine to generate the field prompt audio file.

3. The method of claim 1, further comprising:
identifying an additional field in the digital document comprising one of a multiple choice question or a text field;
providing an additional field prompt audio file comprising a prompt to give verbal information corresponding to the additional field;
converting the verbal information to text; and
wherein generating the signed digital document further comprises filling the additional field based on the text.

4. The method of claim 1, further comprising embedding the authenticated audio clip approving the signature into the signed digital document.

5. The method of claim 1, further comprising:
identifying biometric data corresponding to a user account associated with the audio signature; and
authenticating the audio response utilizing the biometric data.

6. The method of claim 1, further comprising:
in response to generating the signed digital document, providing the signed digital document to an additional client device;
receiving, from the additional client device, a non-verbal digital signature; and
applying the non-verbal digital signature to the signed digital document.

7. The method of claim 1, wherein generating the signed digital document further comprises generating and applying an indication that the audio signature was received by voice to the signed digital document.

8. A non-transitory computer-readable medium storing instructions that, when executed by at least one processor, cause a computer system to:
generate a field prompt audio file from a digital document comprising a signable field, wherein the field prompt audio file comprises audio prompting audible response to the signable field of the digital document;
provide the field prompt audio file for audible presentation by a client device;
receive an audio response to the field prompt audio file from the client device, the audio response comprising audible approval for signing the signable field within the digital document;
generate, from the audio response, an audio signature comprising an authenticated audio clip approving signature of the signable field within the digital document; and
generate a signed digital document by applying the audio signature to the digital document.

9. The non-transitory computer-readable medium of claim 8, further comprising instructions that, when executed by the at least one processor, cause the computer system to:
provide the digital document to an optical character recognition engine to generate text; and
provide the text to a speech engine to generate the field prompt audio file.

10. The non-transitory computer-readable medium of claim 8, further comprising instructions that, when executed by the at least one processor, cause the computer system to:
identify an additional field in the digital document comprising one of a multiple choice question or a text field;
provide an additional field prompt audio file comprising a prompt to give verbal information corresponding to the additional field;
convert the verbal information to text; and
wherein generating the signed digital document further comprises filling the additional field based on the text.

11. The non-transitory computer-readable medium of claim 8, further comprising instructions that, when executed by the at least one processor, cause the computer system to embed the authenticated audio clip approving the signature into the signed digital document.

12. The non-transitory computer-readable medium of claim 8, further comprising instructions that, when executed by the at least one processor, cause the computer system to:
identify biometric data corresponding to a user account associated with the audio signature; and
authenticate the audio response utilizing the biometric data.

13. The non-transitory computer-readable medium of claim 8, further comprising instructions that, when executed by the at least one processor, cause the computer system to:
in response to generating the signed digital document, provide the signed digital document to an additional client device;
receive, from the additional client device, a non-verbal digital signature; and
apply the non-verbal digital signature to the signed digital document.

14. The non-transitory computer-readable medium of claim 8, wherein generating the signed digital document further comprises generating and applying an indication that the audio signature was received by voice to the signed digital document.

15. A system comprising:
at least one processor; and
at least one non-transitory computer-readable storage medium storing instructions that, when executed by the at least one processor, cause the system to:
generate a field prompt audio file from a digital document comprising a signable field;
provide the field prompt audio file for audible presentation by a client device;
receive an audio response to the field prompt audio file from the client device, the audio response comprising audible approval for signing the signable field within the digital document;
generate, based on determining that the audio response comprises the audible approval, an audio signature comprising an authenticated audio clip approving signature of the signable field within the digital document; and
generate a signed digital document by applying the audio signature to the digital document.

16. The system of claim 15, further comprising instructions that, when executed by the at least one processor, cause the system to:
provide the digital document to an optical character recognition engine to generate text; and
provide the text to a speech engine to generate the field prompt audio file.

17. The system of claim 15, further comprising instructions that, when executed by the at least one processor, cause the system to:
identify an additional field in the digital document comprising one of a multiple choice question or a text field;
provide an additional field prompt audio file comprising a prompt to give verbal information corresponding to the additional field;
convert the verbal information to text; and
wherein generating the signed digital document further comprises filling the additional field based on the text.

18. The system of claim 15, further comprising instructions that, when executed by the at least one processor, cause the system to:
identify biometric data corresponding to a user account associated with the audio signature; and
authenticate the audio response utilizing the biometric data.

19. The system of claim 15, further comprising instructions that, when executed by the at least one processor, cause the system to:
in response to generating the signed digital document, provide the signed digital document to an additional client device;
receive, from the additional client device, a non-verbal digital signature; and
apply the non-verbal digital signature to the signed digital document.

20. The system of claim 15, wherein generating the signed digital document further comprises generating and applying an indication that the audio signature was received by voice to the signed digital document.
